(19) United States
(12) Patent Application Publication
(10) Pub. No.: US 2021/0027924 A1
(43) Pub. Date: Jan. 28, 2021

(54) SOFT MAGNETIC COMPOSITES

(71) Applicant: AGENCY FOR SCIENCE, TECHNOLOGY AND RESEARCH, Singapore (SG)

(72) Inventors: Pei WANG, Singapore (SG); Cheng Cheh Dennis TAN, Singapore (SG); Dongzhi CHI, Singapore (SG)

(21) Appl. No.: 17/040,107

(22) PCT Filed: Mar. 22, 2019
(86) PCT No.: PCT/SG2019/050157

§ 371 Date: Sep. 22, 2020

(30) Foreign Application Priority Data
Mar. 22, 2018 (SG) 10201802348R

(51) Int. Cl. H01F 1/22; B22F 1/02; B22F 3/105; B33Y 80/00; C22C 33/02; C22C 38/10; C01B 32/168; B22F 9/04

(52) U.S. Cl. CPC H01F 1/22; B22F 1/02; B22F 3/1055; B33Y 80/00; B33Y 70/00; C22C 38/10; C01B 32/168; B22F 9/04; C22C 33/0285

(57) ABSTRACT

The present disclosure generally relates to a soft magnetic composite (100) and a method (200) of manufacturing the soft magnetic composite (100). The soft magnetic composite (100) comprises composite elements (102) that are fused together. The composite elements (102) comprise: magnetic microparticles (104) formed of a soft magnetic material; and additive objects (106) deposited on the magnetic microparticles (104), the additive objects (106) being smaller than the magnetic microparticles (104), wherein the soft magnetic composite (100) is formed by an additive manufacturing process that fused the composite elements (102) together.

### CROSS REFERENCE TO RELATED APPLICATION(S)

The present disclosure claims the benefit of Singapore Patent Application No. 10201802348R filed on 22 Mar. 2018, which is incorporated in its entirety by reference herein.

### TECHNICAL FIELD

The present disclosure generally relates to soft magnetic composites. More particularly, the present disclosure describes various embodiments of a soft magnetic composite and a method of manufacturing the soft magnetic composite.

### BACKGROUND

Conventional aircrafts use conventional engines with different types of systems, namely electrical, pneumatic, hydraulic, and mechanical. For example, in an Airbus A330 or a Boeing 777 aircraft, the engine(s) has various subsystems that are driven by electrical power. Specifically, the engine has electrical subsystems such as gearbox driven generators which may consume 200 kW of power, pneumatic subsystems such as high pressure air bleed from the engine that may consume 1.2 MW of power, hydraulic subsystems such as gearbox driven hydraulic pumps which may consume 240 kW of power, and mechanical subsystems such as fuel pumps and oil pumps on the engine which may consume 100 kW of power. Collectively, the engine subsystems consume around 1.7 MW of non-thrust power in addition to 40 MW of power consumption for propulsion thrust from the engine.

The high power consumption of conventional aircrafts has led to developments to optimize aircraft performance, decrease operating and maintenance costs, increase dispatch reliability, and reduce gas emissions. These developments have underscored the aircraft industry's progress toward the concept of More Electric Aircraft (MEA) and More Electric Engine (MEE), and ultimately an all-electric aircraft. The MEE modifies the electrical power networks of the engine subsystems by removing the power networks for the pneumatic, hydraulic, and mechanical subsystems. The MEE has engine driven generators to supply electrical power for existing electrical loads and additional electrical loads such as cabin pressurization, air conditioning, icing protection, surface actuation, landing gear, brakes, doors, fuel pumps, and other engine ancillaries. The MEE may achieve a reduced collective power consumption of around 1 MW.

As the MEA and MEE continue to be developed, key electric power-related components and materials need to be developed or refined to meet the power objectives described above. These components and materials should be lightweight, fault tolerant, and reliable. However, engineers are currently limited to off-the-shelf components and materials that may not be optimized for use in aeronautics and aviation. For example, these components and materials may be too heavy for many practical aviation uses, and contribute to significant power loss and large amounts of waste heat.

Soft magnets or magnetic materials have been considered to address this problem. Soft magnetic materials are easily magnetized and demagnetized by controlling the electrical power supplied to the materials. Soft magnetic materials can be used to fabricated smaller, more lightweight power electronic components for aircraft power electronics in MEE/MEA. The soft magnetic materials should ideally reduce the collective power consumption of the MEE/MEA and contribute to increased power efficiency of the MEE/MEA.

Therefore, there is a need to provide improved soft magnetic composites that address at least one of the aforementioned problems/disadvantages and to achieve the aforementioned objectives.

### SUMMARY

According to a first aspect of the present disclosure, there is a soft magnetic composite comprising composite elements that are fused together. The composite elements comprise: magnetic microparticles formed of a soft magnetic material; and additive objects deposited on the magnetic microparticles, the additive objects being smaller than the magnetic microparticles, wherein the soft magnetic composite is formed by an additive manufacturing process that fused the composite elements together.

According to a second aspect of the present disclosure, there is a method of manufacturing a soft magnetic composite. The method comprises: preparing a magnetic powder comprising magnetic microparticles formed of a soft magnetic material; preparing additive objects that are smaller than the magnetic microparticles; forming a mixture of composite elements from the magnetic powder and additive objects, the composite elements comprising the magnetic microparticles and the additive objects deposited on the magnetic microparticles; and performing an additive manufacturing process to form the soft magnetic composite from the mixture of composite elements, the additive manufacturing process comprising fusing the composite elements together.

An advantage of one or more aspects of the present disclosure is that the soft magnetic composite exhibits both strong tensile strength and high magnetic performance as soft magnets. Particularly, the soft magnetic composite manufactured by the additive manufacturing process has better tensile strength and ductility than conventional casted and sintered soft magnets without compromising on magnetic properties and performance, even at high temperatures. The soft magnetic composite is thus suitable to be used as soft magnets in harsh environment conditions, such as under high operating temperatures when used in electrical systems in an aircraft engine.

Soft magnetic composites according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIG. 1A and FIG. 1B are illustrations of soft magnetic composites.

FIG. 2 is a flowchart illustration of a method of manufacturing a soft magnetic composite.

FIG. 3 is an illustration of a ball mill used in the method of manufacturing the soft magnetic composite.

FIG. 4 is an illustration of an additive manufacturing machine used in the method of manufacturing the soft magnetic composite.

FIG. 5A and FIG. 5B are illustrations of the method of manufacturing the soft magnetic composite.

FIG. 6A and FIG. 6B are illustration of a test coupon formed from the soft magnetic composite.

FIG. 7A to FIG. 7G are illustrations of results of tests performed on the test coupons.

### DETAILED DESCRIPTION

For purposes of brevity and clarity, descriptions of embodiments of the present disclosure are directed to soft magnetic composites in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” herein, in a figure, or in associated text is understood to mean “and/or” unless otherwise indicated. The recitation of a particular numerical value or value range herein is understood to include or be a recitation of an approximate numerical value or value range.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment. As used herein, the terms “a” and “an” are defined as one or more than one. The use of “/” in a figure or associated text is understood to mean “and/or” unless otherwise indicated.

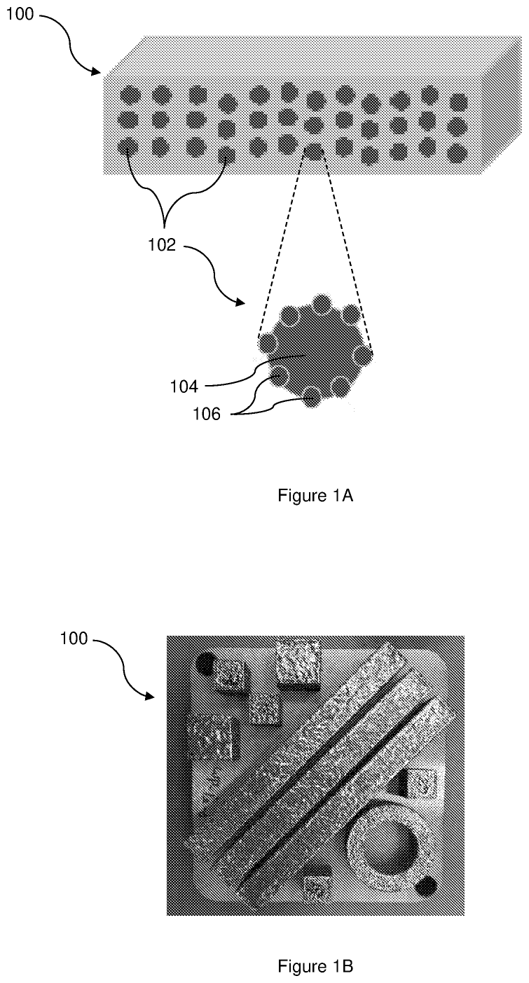

In representative or exemplary embodiments of the present disclosure, there is a soft magnetic composite 100 as shown in FIG. 1A. The soft magnetic composite 100 includes composite elements 102 that are fused together. The composite elements 102 are constituent parts of the soft magnetic composite 100. The composite elements 102 include magnetic microparticles 104 formed of a soft magnetic material. The composite elements 102 further include additive objects 106 deposited on the magnetic microparticles 104, the additive objects 106 being smaller than the magnetic microparticles 104. The additive objects 106 may constitute approximately 0.25% of the composite elements 102 by weight, wherein the magnetic microparticles 104 constitute the remaining 99.75%. Additionally, the soft magnetic composite 100 is formed by an additive manufacturing process that fused the composite elements 102 together. In the soft magnetic composite 102, The additive manufacturing process enable the soft magnetic composite 100 to be formed in various shapes and/or sizes, some of which are shown in FIG. 1B.

The magnetic microparticles 104 are microscale particles, i.e. particles having dimensions ranging from 1 to 100 μm. Preferably, the magnetic microparticles 104 have dimensions ranging from 15 to 45 μm. For example, the magnetic microparticles 104 are microspheres with diameters ranging from 15 to 45 μm. The magnetic microparticles 104 has a soft magnetic material that is easily magnetized and demagnetized by controlling electrical current flow. In many embodiments, the soft magnetic material includes an iron-cobalt (FeCo) alloy. It will be appreciated that there may be other soft magnetic materials such as, but not limited to, iron-silicon (FeSi) alloy, nickel-iron (NiFe) alloy, and other ferrite-constituent materials. The magnetic microparticles 104 may also be referred to as metallic matrix composites as they have a metallic material such as iron as a constituent.

The additive objects 106 preferably include nanoscale objects, i.e. having dimensions ranging from 1 to 100 nm. The nanoscale objects or nanofillers may include nanoparticles, nanotubes, and nanofibers. The additive objects 106 may also include microscale objects such as microparticles. In many embodiments, the additive objects 106 are formed of a ceramic and/or metallic material. Specifically, the ceramic/metallic material includes one or more of titanium carbide (TiC), alumina/aluminum oxide (Al₂O₃), and carbon (C). It will be appreciated that there may be other ceramic/metallic materials suitable for the additive objects 106 deposited on the magnetic microparticles 104.

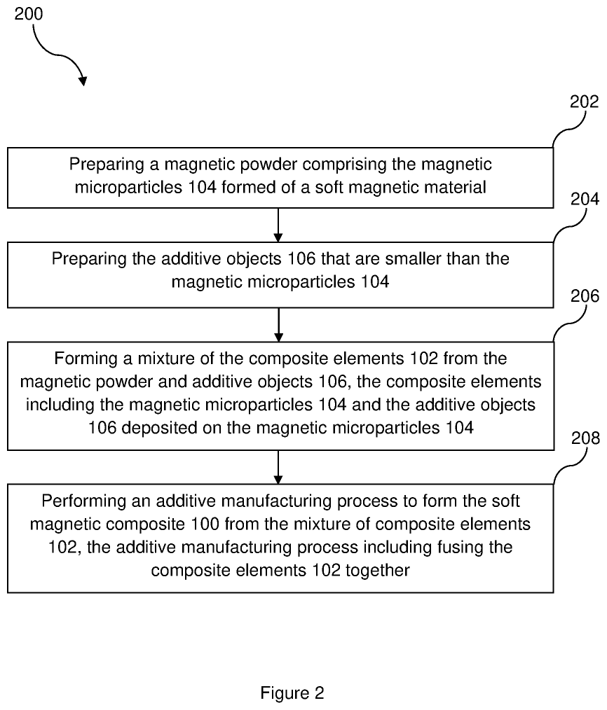

With reference to FIG. 2, there is a method 200 of manufacturing the soft magnetic composite 100. The method 200 includes a step 202 of preparing a magnetic powder comprising the magnetic microparticles 104 formed of a soft magnetic material. In some embodiments, the magnetic powder is an iron-cobalt alloy powder that is supplied by Sandvik Osprey. The iron-cobalt alloy powder is atomized by argon gas and has spherical iron-cobalt alloy microparticles 104 with particle size distribution ranging from 15 to 45 μm. The iron-cobalt alloy powder has approximately equal weights of iron and cobalt. For example, the iron-cobalt alloy powder contains approximately 47.9% cobalt by weight. Other constituents of the iron-cobalt alloy powder include 0.01% sulphur, 0.12% oxygen, 0.01% carbon, 0.005% phosphorus, and 0.003% silicon. Iron constitutes the remainder of the iron-cobalt alloy powder (approximately 51.95% by weight).

The method 200 further includes a step 204 of preparing the additive objects 106 that are smaller than the magnetic microparticles 104. In some embodiments, the additive objects 106 include one or more of titanium carbide nanoparticles, alumina microparticles, and carbon nanotubes (CNT). The titanium carbide nanoparticles may be supplied by Sigma-Aldrich and have dimensions below 50 nm. The alumina microparticles may be supplied by Sigma-Aldrich and have dimensions below 10 μm. The carbon nanotubes may be nickel-coated multi-walled carbon nanotubes (MWCNT) supplied by US Research Nanomaterials.

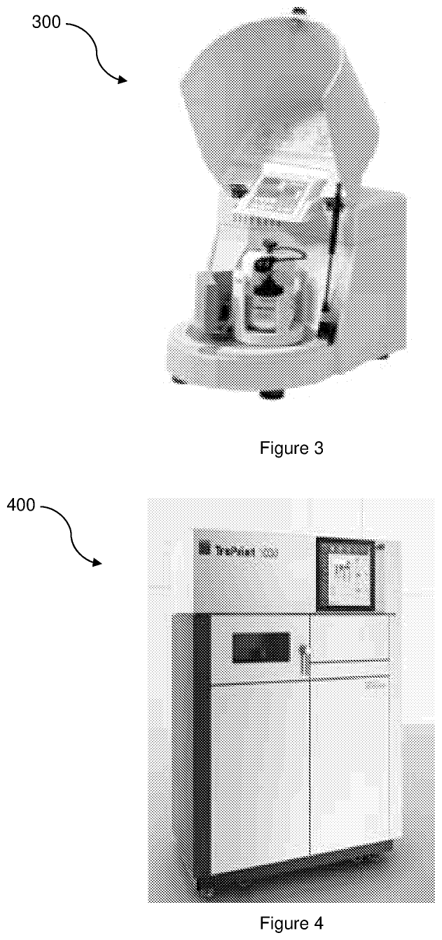

The method 200 further includes a step 206 of forming a mixture of the composite elements 102 from the magnetic powder and additive objects 106. The composite elements 102 include the magnetic microparticles 104 and the additive objects 106 deposited on the magnetic microparticles 104. Specifically, the mixture is formed such that the additive objects 106 are uniformly dispersed with the magnetic powder to deposit the additive objects 106 on the surfaces of the magnetic microparticles 104. During said deposition, chemical bonds, such as but not limited to metal-oxygen, metal-nitrogen, and metal-carbon bonds, are formed between surfaces of the additive objects 106 and magnetic microparticles 104, as will be readily understood by the skilled person. In some embodiments, said forming of the mixture includes milling the magnetic powder and additive objects 106 together, such as by using a ball mill 300 as shown in FIG. 3. For example, the ball mill 300 is a planetary ball mill such as the Planetary Mono Mill Pulverisette 6 supplied by Fritsch.

The magnetic powder and additive objects 106 are milled and physically blended together in the ball mill 300 based on a ball-to-mass ratio of approximately 2:1. The ball-to-mass ratio refers to the ratio of the weight of the ball to the weight of the mixture of composite elements 102, i.e. the combined weight of the magnetic powder and additive objects 106. The ball is used to contain the mixture to mill and blend the magnetic powder and additive objects 106 together. The additive objects 106 may constitute approximately 0.25% of the mixture by weight and the magnetic powder may constitute the remaining 99.75% of the mixture by weight. Said milling by the ball mill 300 may occur for 580 minutes in total with 20-minute interruptions between 20-minute intervals of milling.

In some embodiments, said forming of the mixture of composite elements 102 further includes drying the milled mixture after said milling. Specifically, the mixture is sieved and collected after said milling for drying. The milled mixture is dried at approximately 100° C. for approximately 12 hours to remove moisture from the mixture.

The method further includes a step 208 of performing an additive manufacturing process to form the soft magnetic composite 100 from the mixture of composite elements 102. The additive manufacturing process includes fusing the composite elements 102 together.

In some embodiments, the additive manufacturing process is laser aided or assisted and may be known as a laser aided additive manufacturing (LAAM) process. The LAAM process uses laser as a heat source for depositing additive material on a substrate or surface with metallurgical bond achieved by fusing elements together by the laser. In one embodiment, the LAAM process is performed by the TruPrint 1000 machine 400 supplied by Trumpf, as shown in FIG. 4.

In another embodiment, the LAAM process is performed by the SLM 250HL machine supplied by SLM Solutions Group AG. The SLM 250HL machine utilizes selective laser melting (SLM) as one type of the LAAM process. SLM is also known as direct metal laser sintering (DMLS) or laser powder bed fusion (LPBF) that uses a high energy laser to melt and fuse metallic powders together. The SLM 250HL machine is equipped with a 400 W YLR-Fraser-Laser for printing samples of the soft magnetic composite 100. The laser has a spot size of 80 μm and a scanning speed of up to 20 m/s.

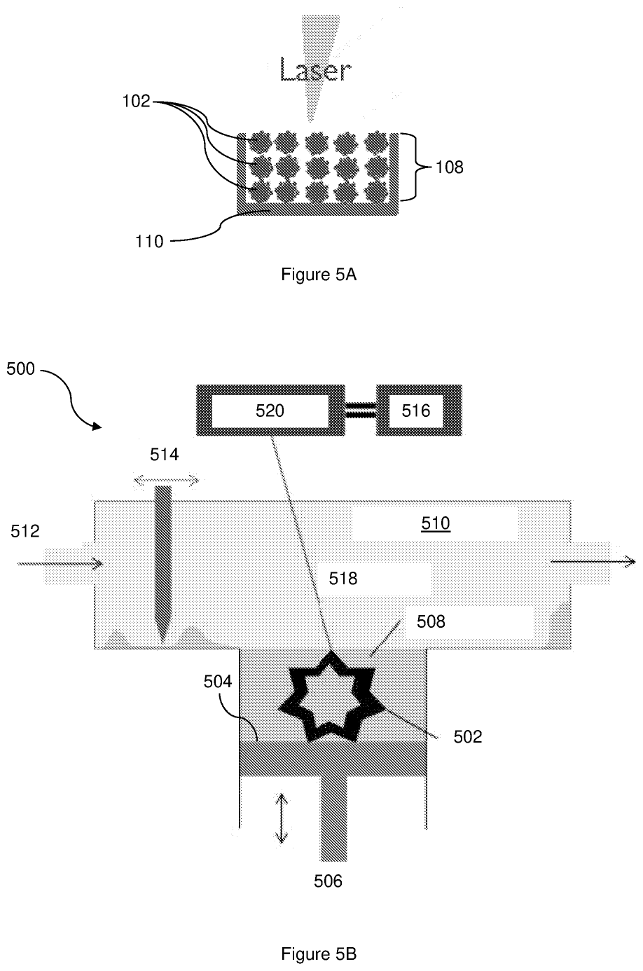

In some embodiments with reference to FIG. 5A, the LAAM process is performed by the SLM 250HL machine using SLM is a layered manufacturing technique that forms a plurality of successive layers 108 of the fused composite elements 102. The layers 108 are formed on a substrate or building plate 110 that may be formed of a stainless steel material. In one embodiment, each layer 108 has a thickness of approximately 50 μm and the soft magnetic composite 100 has 400 layers 108 of the fused composite elements 102, resulting in an overall thickness of approximately 20 mm.

FIG. 5B illustrates a schematic 500 of the working principle of SLM performed by the SLM 250HL machine. The LAAM process using SLM forms an SLM part 502 on a substrate 504 that is disposed on a retractable platform 506. The mixture of composite elements 102 is a metallic powder 508 that is fed into a building chamber 510. The building chamber 510 provides an ambient atmosphere for performing the LAAM process. The ambient atmosphere has an inert gas 512 that is supplied into the building chamber 510. A non-limiting example of the inert gas 512 is argon. Ideally, there is no oxygen in the building chamber 510. In some instances of the LAAM process, the oxygen level in the building chamber 510 was monitored to be no more than 0.5% of the ambient atmosphere by volume. A wiper 514 distributes the fed metallic powder 508 to deposit a successive layer over the SLM part 502. A laser source 516 generates a laser beam 518 and cooperates with an XY actuator or scanner 520 configured to move the laser beam 518. The laser beam 518 heats the successive layer of metallic powder on the SLM part 502, fuses the composite elements 102 thereof, and forms the successive layer of the fused composite elements 102 on the SLM part 502. Notably, the XY actuator 520 is configured to move the laser beam 518 along the X-axis and Y-axis and the retractable platform 506 is configured to move the SLM part 502 along the Z-axis.

There are various parameters of the LAAM process using SLM that can be configured to modify how the soft magnetic composites 100 are formed. In some instances of the LAAM process, the laser power is 360 W, laser scanning speed is 400 mm/s, layer thickness is 50 μm, hatch spacing is 0.125 mm, island length is 5 mm by 5 mm, and island overlap is 1 mm. Additionally, the LAAM process is configured for no re-melting.

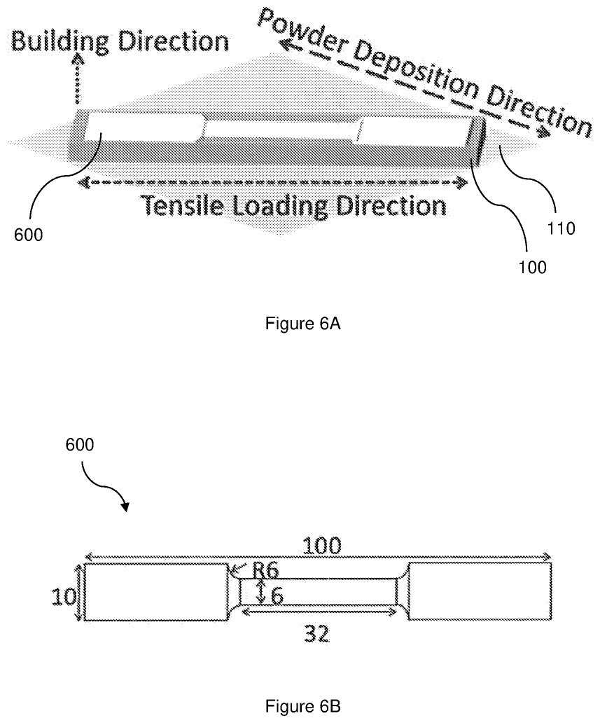

In one embodiment with reference to FIG. 6A, the substrate 110 has dimensions 100 mm along the X-axis and 100 mm along the Y-axis. The soft magnetic composite 100 is formed in the shape of a rectangular bar with length 110 mm, widest width 14 mm, and thickness 20 mm. Additionally, the length of the soft magnetic composite 100 is along the diagonal of the substrate 110. The layers 108 of the soft magnetic composite 100 are successively formed along the Z-axis or building direction. In each layer 108, the composite elements 102 are fused by the laser beam along the X-axis or powder deposition direction.

Further with reference to FIG. 6B, the rectangular soft magnetic composite 100 is fabricated, such as by cutting and/or machining, into test coupons 600. Each test coupon 600 has a thickness of at least 2 mm and has a flat dog-bone shape according to the ASTM E8/E8M 13a/16a codes on Standard Test Methods for Tension Testing of Metallic Materials.

Depending on the soft magnetic material of the magnetic microparticles 104 and the material of the additive objects 106, various types of soft magnetic composites 100 are manufactured by the method 200, specifically using the LAAM process and SLM. The soft magnetic composites 100 include a TiC-FeCo composite, an alumina-FeCo composite, and a CNT-FeCo composite. Tests according to the ASTM E8/E8M 13a/16a codes were performed on the test coupons 600 fabricated from the soft magnetic composites 100. For comparison, the tests were also performed on reference test coupons fabricated from other metallic matrix composites including wrought FeCo alloy (e.g. a casted soft magnet), sintered FeCo alloy (e.g. a sintered soft magnet), and LAAM-FeCo alloy that is without the additive objects 106 and manufactured by the LAAM process. During the tests, the tensile properties of the test coupons 600 and reference test coupons were assessed by tensioning or tensile loading the test coupons 600 and reference test coupons along their lengths which are transverse to the powder deposition direction.

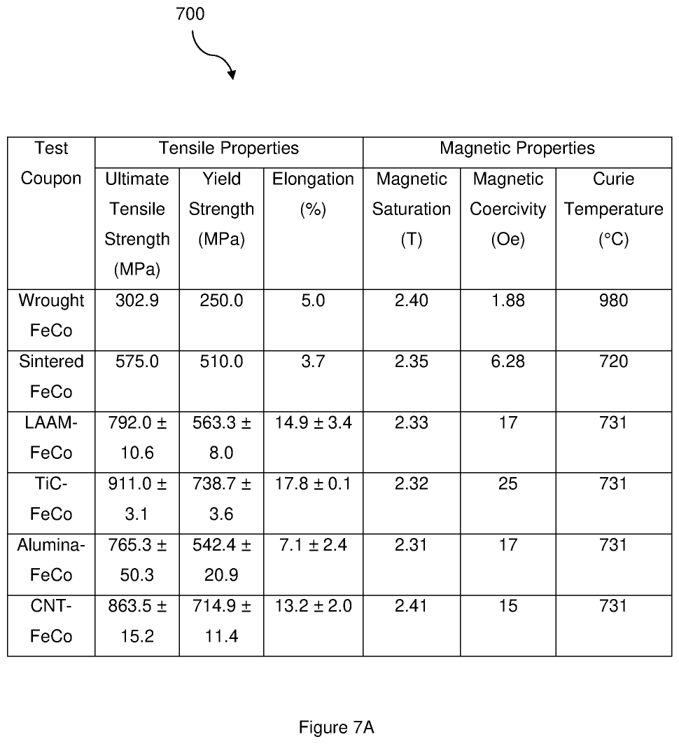

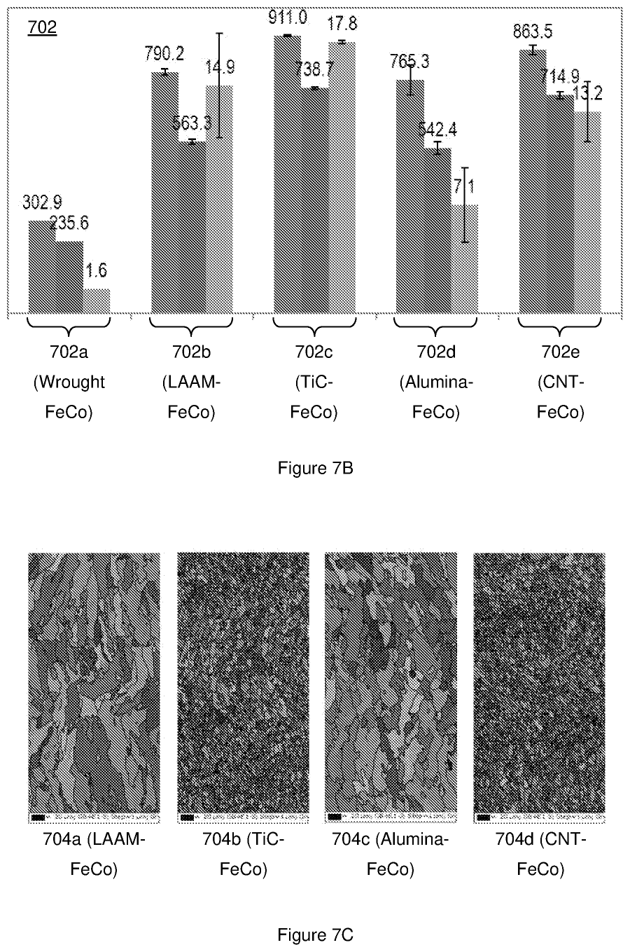

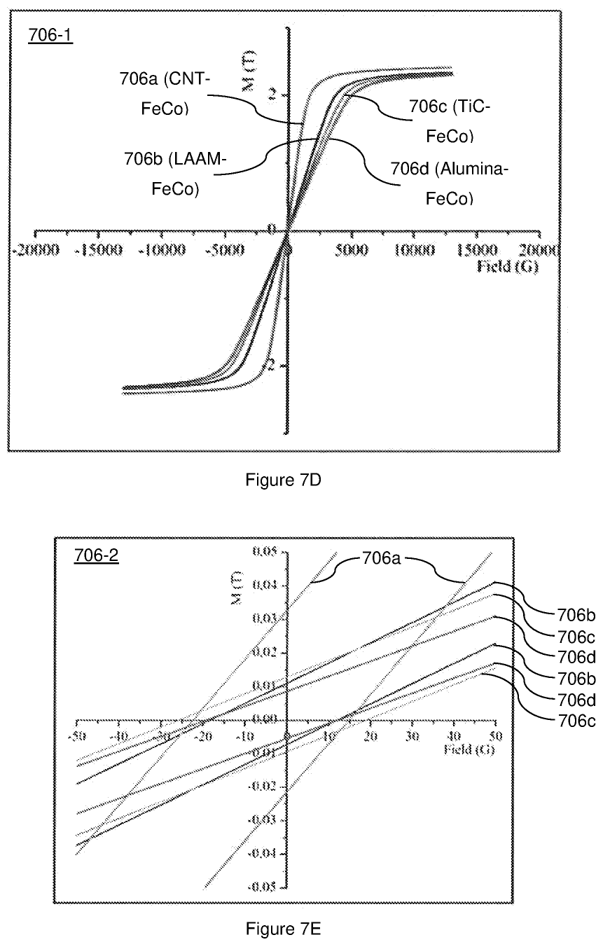

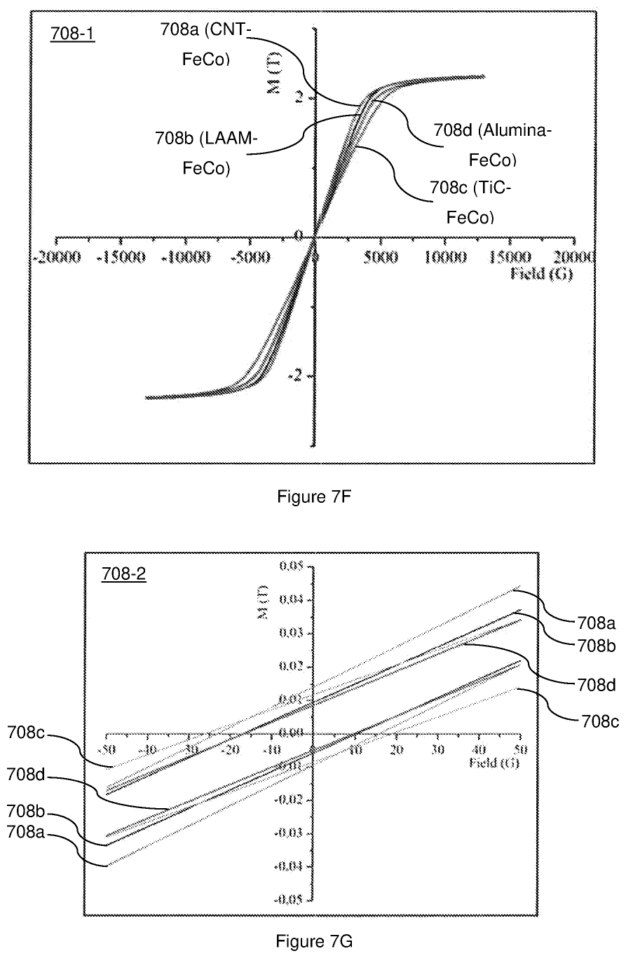

FIG. 7A illustrates a table 700 comparing the tensile and magnetic properties of the test coupons 600 and reference test coupons. FIG. 7B illustrates a graph 702 comparing the tensile properties of the test coupons 600 and reference test coupons. The graph 702 shows bar groups 702a-e for each of the wrought FeCo alloy, LAAM-FeCo alloy, TiC-FeCo composite, alumina-FeCo composite, and CNT-FeCo composite, respectively. Each of the bar groups 702a-e has three bars. The first (left) bars represent the ultimate tensile strength which is the maximum stress that a material can withstand while being stretched or pulled before breaking. The second (middle) bars represent the yield strength which is the stress at which the amount of plastic deformation produced is approximately 0.2% of the unstressed length. The third (right) bars represent the elongation percentage of the unstressed length of the material at the point of fracture. The test results showed that the LAAM-FeCo alloy, TiC-FeCo composite, alumina-FeCo composite, and CNT-FeCo composite have stronger ultimate tensile strength and yield strength properties, and better elongation property (ductility) than wrought and sintered FeCo alloys. Particularly, the TiC-FeCo composite and CNT-FeCo composite have stronger ultimate tensile strength and yield strength properties than the LAAM-FeCo alloy and alumina-FeCo composite.

The better strength properties are because of the grain refinement caused by the TiC and CNT additive objects 106 that are deposited on the FeCo magnetic microparticles 104 and served as nanofillers in the soft magnetic composites 100. With reference to FIG. 7C, this grain refinement can be seen in electron backscatter diffraction (EBSD) maps 704a-d of the LAAM-FeCo alloy, TiC-FeCo composite, alumina-FeCo composite, and CNT-FeCo composite, respectively. The EBSD maps 704a-d show that the LAAM process using SLM achieves finer grains and that the additive objects 106, especially nanoscale objects such as TiC and CNT, further refines the grains.

The magnetic properties of the test coupons 600 and reference test coupons were assessed by magnetic hysteresis measurements. FIG. 7D and FIG. 7E illustrates a magnetic hysteresis graph 706-1 and a magnified version 706-2 of the graph 706-1. The graphs 706-1 and 706-2 show the magnetic hysteresis loops 706a-d measured from the LAAM-FeCo alloy, TiC-FeCo composite, alumina-FeCo composite, and CNT-FeCo composite, respectively. Specifically, in the graphs 706-1 and 706-2, the magnetic hysteresis measurements were performed perpendicular to the Z-axis or building direction of the soft magnetic composites 100, i.e. along the XY-plane. FIG. 7F and FIG. 7G illustrates a magnetic hysteresis graph 708-1 and a magnified version 708-2 of the graph 708-1. The graphs 708-1 and 708-2 show the magnetic hysteresis loops 708a-d measured from the LAAM-FeCo alloy, TiC-FeCo composite, alumina-FeCo composite, and CNT-FeCo composite, respectively. Specifically, in the graphs 708-1 and 708-2, the magnetic hysteresis measurements were performed parallel to the Z-axis or building direction of the soft magnetic composites 100.

The magnetic saturation values of the test coupons 600 and reference test coupons can be determined from their magnetic hysteresis measurements. Magnetic saturation in a magnetic material is the state reached when an increase in applied external magnetic field cannot increase the magnetization of the magnetic material further. Similar to the wrought and sintered FeCo alloys, the LAAM-FeCo alloy, TiC-FeCo composite, alumina-FeCo composite, and CNT-FeCo composite have magnetic saturation values greater than a threshold value of 2 T. Particularly, the CNT-FeCo composite has the highest magnetic saturation value. The magnetic saturation threshold value of 2 T is a standard for all soft magnets used to generate stronger electromagnetic forces Based on Lorentz force physics, larger saturation values result in stronger electromagnetic forces. A high purity steel has a magnetic saturation value of 2 T but it is very soft. Stronger steels with additional elements, such as silicon, boron, or carbon, to improve its strength will have significantly reduction in magnetic saturation.

The magnetic coercivity values of the test coupons 600 and reference test coupons can also be determined from their magnetic hysteresis measurements. Magnetic coercivity is a measure of the ability of a magnetic material to withstand an external magnetic field without becoming demagnetized. In other words, magnetic coercivity measures the resistance of a magnetic material to becoming demagnetized. Magnetic materials with high magnetic coercivity are “magnetically hard” and are suitable to make permanent magnets. Magnetic materials with low magnetic coercivity are “magnetically soft” and are suitable to make soft magnets. As shown in the table 700, although the LAAM-FeCo alloy, TiC-FeCo composite, alumina-FeCo composite, and CNT-FeCo composite have greater magnetic coercivity values than that of the wrought and sintered FeCo alloys, they are still suitable to make soft magnets.

The table 700 also shows the Curie points or Curie temperature values of the test coupons 600 and reference test coupons. The Curie point is the temperature above which certain magnetic materials lose their permanent magnetic properties that are replaced by induced magnetism. The Curie temperature values for all FeCo alloys generally range from 667° C. to 1300° C. The LAAM-FeCo alloy, TiC-FeCo composite, alumina-FeCo composite, and CNT-FeCo composite have Curie temperature values greater than 720° C., which is the Curie temperature value for sintered FeCo alloy. The soft magnetic composite 100 is thus suitable to be used as magnetic materials under high operating temperatures, such as in an MEE where the temperature requirement is above 300° C. The soft magnetic composite 100 is also suitable for applications below 720° C.

The test results showed that the soft magnetic composites 100 exhibit both strong tensile strength and high magnetic performance as soft magnets. Particularly, the soft magnetic composites 100 manufactured by the additive manufacturing process, such as the LAAM process using SLM, have better tensile strength and ductility than conventional casted and sintered soft magnets without compromising on their magnetic properties and performance. The LAAM process can achieve refined grain size and tailored microstructure which result in excellent mechanical properties as well as wear and corrosion resistance. The high Curie temperature values of the soft magnetic composites 100 qualify them as potential candidates as soft magnets in harsh environment conditions, such as under high operating temperatures (above 300° C.) when used in electrical systems in an aircraft engine.

The requirement of ultimate tensile strength for an aircraft or jet engine is greater than 1 GPa. The strength properties of the soft magnetic composites 100 achieve close to this requirement, making the soft magnetic composites 100 suitable for used in the engine. The soft magnetic composites 100 also achieve a low core loss of less than 800 W/kg at 4 kHz. This core loss is another requirement for the engine or high speed motor applications in general.

The soft magnetic composite 100 thus has potential to further progress toward the concept of MEA and MEE in aviation and the aircraft industry. Adoption of the MEA concept is seen as critical enabler for the aircraft industry to unlock significant improvements in terms of aircraft weight, fuel consumption, total life cycle costs, maintainability, and aircraft reliability. In addition to aviation and the aircraft industry, the soft magnetic composite 100 may broader applications in electric transportation systems, such as electric vehicles (e.g. electric cars) and electric marine propulsion for marine vessels. Use of the soft magnetic composite 100 in such electric transportation systems may facilitate provision of clean energy for operating the systems, thereby reducing carbon dioxide emissions, saving excess weights, and improving overall efficiencies and cost effectiveness. For example, in electric cars, the use of the soft magnetic composite 100 may contribute to electrical circuits with lower power loss and lower amounts of waste heat.

In the foregoing detailed description, embodiments of the present disclosure in relation to soft magnetic composites are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A soft magnetic composite comprising composite elements that are fused together, the composite elements comprising:
magnetic microparticles formed of a soft magnetic material; and
additive objects deposited on the magnetic microparticles, the additive objects being smaller than the magnetic microparticles,
wherein the soft magnetic composite is formed by an additive manufacturing process that fused the composite elements together.

2. The soft magnetic composite according to claim, comprising a plurality of successive layers of the fused composite elements formed by the additive manufacturing process.

3. The soft magnetic composite according to claim 1 or 2, wherein the additive manufacturing process is laser aided.

4. The soft magnetic composite according to any one of claims 1 to 3, wherein the soft magnetic material comprises an iron-cobalt alloy.

5. The soft magnetic composite according to any one of claims 1 to 4, wherein the additive objects are formed of a material comprising one or more of titanium carbide, alumina, and carbon.

6. The soft magnetic composite according to any one of claims 1 to 5, wherein the additive objects comprise nanoscale objects.

7. The soft magnetic composite according to any one of claims 1 to 6, wherein the additive objects comprise one or more of titanium carbide nanoparticles, alumina microparticles, and carbon nanotubes.

8. The soft magnetic composite according to any one of claims 1 to 7, wherein the additive objects constitute approximately 0.25% of the composite elements by weight.

9. A method of manufacturing a soft magnetic composite, the method comprising:
preparing a magnetic powder comprising magnetic microparticles formed of a soft magnetic material;
preparing additive objects that are smaller than the magnetic microparticles;
forming a mixture of composite elements from the magnetic powder and additive objects, the composite elements comprising the magnetic microparticles and the additive objects deposited on the magnetic microparticles; and
performing an additive manufacturing process to form the soft magnetic composite from the mixture of composite elements, the additive manufacturing process comprising fusing the composite elements together.

10. The method according to claim 9, the additive manufacturing process further comprising forming a plurality of successive layers of the fused composite elements.

11. The method according to claim 10, wherein each layer has a thickness of approximately 50 μm.

12. The method according to any one of claims 9 to 11, wherein the additive manufacturing process is laser aided.

13. The method according to claim 12, wherein the laser aided additive manufacturing process is performed in an ambient atmosphere comprising an inert gas.

14. The method according to any one of claims 9 to 13, said forming of the mixture comprising:
milling the magnetic powder and additive objects together; and
drying the milled mixture.

15. The method according to claim 14, wherein the magnetic powder and additive objects are milled together in a ball mill based on a ball-to-mass ratio of approximately 2:1.

16. The method according to any one of claims 9 to 15, wherein the soft magnetic material comprises an iron-cobalt alloy.

17. The method according to any one of claims 9 to 16, wherein the additive objects are formed of a material comprising one or more of titanium carbide, alumina, and carbon.

18. The method according to any one of claims 9 to 17, wherein the additive objects comprise nanoscale objects.

19. The method according to any one of claims 9 to 18, wherein the additive objects comprise one or more of titanium carbide nanoparticles, alumina microparticles, and carbon nanotubes.

20. The method according to any one of claims 9 to 19, wherein the additive objects constitute approximately 0.25% of the mixture of composite elements by weight.
